(19) United States
(12) Patent Application Publication
(10) Pub. No.: US 2002/0081193 A1
(43) Pub. Date: Jun. 27, 2002

(54) Ejection rotation power mechanism

(76) Inventor: Tien Lung Hsu, Taipei (TW)

Correspondence Address: Tien Lung Hsu, PO Box 82-144, Taipei, TW

(21) Appl. No.: 09/747,992

(22) Filed: Dec. 27, 2000

(51) Int. Cl. H02K 3/04; F03B 15/06; F03B 3/16

(52) U.S. Cl. 415/146; 310/207; 310/201; 415/202

(57) ABSTRACT

The present invention relates to an ejection rotation power mechanism which includes (a) an externally covered ring mechanism, (b) an eccentric supporting rod mechanism, and (c) a power rotation wheel mechanism, whereby the ejection rotation power mechanism can convert into rotating force and provides stable and high efficient output.

### BACKGROUND OF THE INVENTION

(a) Field of the Invention

The present invention relates to an ejection rotation power mechanism, and in particular, a mechanism which provides high efficient power.

(b) Description of the Prior Art

Medium and small size power mechanisms substantially include fuel-type power generator and electrical generator. Due to the drawback of high cost of the conventional electrical generator, this generator is mostly used in relatively small device and family.

Fuel-type power mechanism is divided into diesel gasoline fuel mechanism. Due to high energy exhaustion, the power output is relatively not stable. The excessive increases or decreases in torsional force will rapidly cause metal fatigue. In addition, the noise and air pollution caused by this power mechanism are also drawback of the conventional art.

### SUMMARY OF THE INVENTION

Accordingly, it is an object of the present invention to provide An ejection rotation power mechanism comprising (a) an externally covered ring mechanism, (b) an eccentric supporting rod mechanism, and (c) a power rotation wheel mechanism, wherein (a) the externally covered ring is associated with the power rotation wheel mechanism connected tangentially with an injection conduit and an oil-dripping tube; and the eccentric supporting rod mechanism is provided to the two lateral sides of the interior of the externally covered ring, the eccentric supporting rod mechanism is positioned eccentrically within the interior of the power rotation mechanism, the front and rear of the horizontal interior of the externally covered ring are provided with a through protruded seat, when the inner power rotation wheel is in operation, the externally covered ring mechanism is stationery; the eccentric supporting rod mechanism comprises a hollow seal module and a supporting rod, wherein the hollow seal has a bearing for the insertion of the shaft of the power rotation wheel and the shaft center of the rotation wheel extends out from the hollow seal and passes through the center hole of the externally covered ring mechanism; the supporting rod has two rod bodies which are respectively supported and engaged at the hollow seal, wherein the front section of the rod body has an arch-shaped locking head, and has an extension spring urging the external section of the externally covered ring mechanism to provide slight eccentricity; the rod body is directly through the protruded seat from the covered ring and is screwed connected with the screw hole at the hollow seal, the end head of the supporting rod is positioned and engaged by means of a locking head; the front end of the rear section of the rod body is similarly connected to the screw hole of the hollow seal, the end head has a locking head to engage at the external side of the hollow seal, the rear end of the rod body passes through from the protruded seat and is locked thereto; the power rotation wheel mechanism has an external edge surface with periodic ejection slot and each ejection slot is an independent structure, the inner bottom section of the slot is provided with a passage which is in communication with the pressure hole at the circumferential side of the ejection slot; the surface of the slot is mounted with a high elasticity rubber pad and a secondary pad ring mounted onto the pressure hole of the circumferential edge.

Yet another object of the present invention is to provide an ejection rotation power mechanism which can covert power into rotating force.

A further object of the present invention is to provide an ejection rotation power mechanism with stable and high efficient output.

Other object and advantages of the present invention will become more apparent from the following description taken in conjunction with the accompanying drawing.

### BRIEF DESCRIPTION OF THE DRAWINGS

FIG. 1 is a schematic view of an ejection rotation power mechanism of the present invention.

FIG. 2 is a schematic view of the front view of the ejection rotation power mechanism.

FIG. 3 is a schematic exploded perspective view of an ejection rotation power mechanism of the present invention.

FIG. 4 is a schematic view showing the relative position of the rotating wheel mechanism and the external enclosed ring structure of the present invention.

FIG. 5 is an enlarged schematic view of portion A of FIG. 4.

FIG. 6 is an enlarged schematic view of portion B of FIG. 4.

FIG. 7 is an exploded view of section C-C of FIG. 4 of the present invention.

FIG. 8 is an exploded view of section D-D of FIG. 4 of the present invention.

FIG. 9 is a second preferred embodiment of the ejection rotation power mechanism of the present invention.

FIG. 10 is a schematic view of the secondary pad of the second preferred embodiment of the present invention.

### DETAILED DESCRIPTION THE PRESENT INVENTION

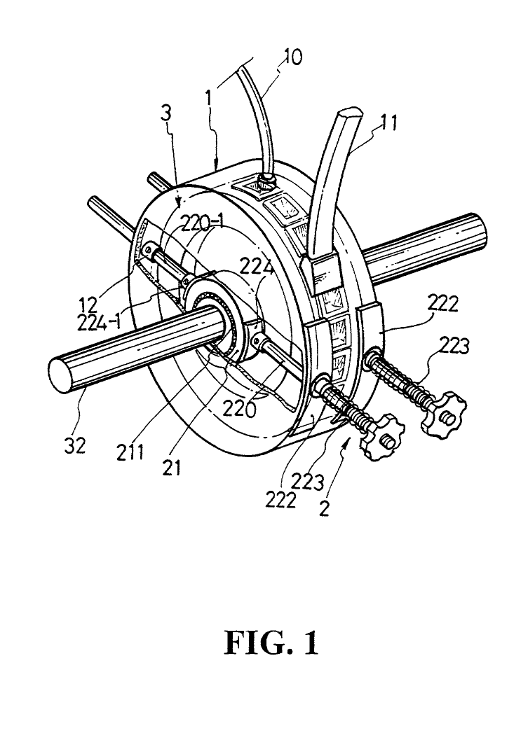

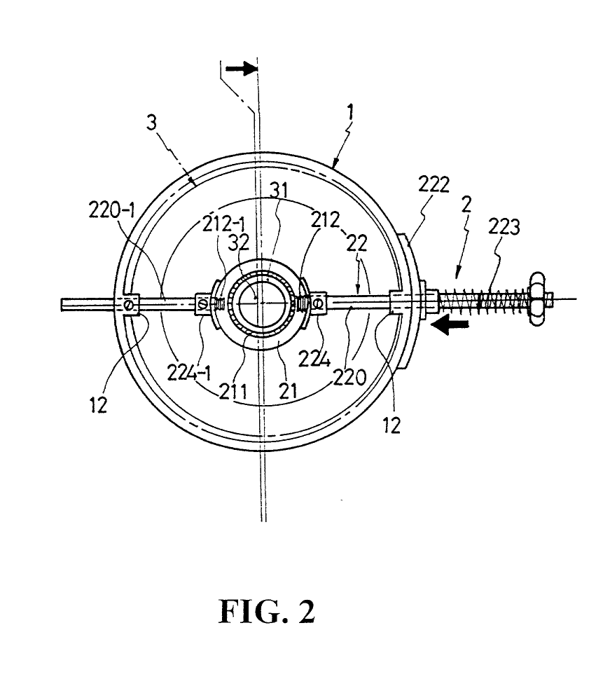

Referring to FIG. 1, there is substantially shown a jet rotation power mechanism comprising (a) an externally covered ring mechanism 1, (b) an eccentric supporting rod mechanism 2, and (c) a power rotation wheel mechanism 3, wherein (a) the externally covered ring 1 is associated with the power rotation wheel mechanism 3 connected tangentially with an injection conduit 11 and an oil-dripping tube 10. The eccentric supporting rod mechanism 2 is provided each the two lateral sides of the interior of the externally covered ring 1. In operation, the externally covered ring mechanism 1 is stationary. Referring to FIG. 2, the externally covered ring mechanism 1 is supported by the eccentric supporting rod mechanism 2, one at each side, so as to support the interior power rotation wheel mechanism 3. In other words, the eccentric supporting rod mechanism 2 is positioned eccentrically within the interior of the power rotation mechanism 3. The front and rear of the horizontal interior of the externally covered ring are provided with a through protruded seat 12. When the inner power rotation wheel 3 is in operation, the externally covered ring mechanism 1 is stationary.

In accordance with the present invention, the eccentric supporting rod mechanism 2 comprises a hollow seal module 21 and a supporting rod 22, wherein the hollow seal 21 has a bearing 211 for the insertion of the shaft 31 of the power rotation wheel 3 and the shaft center 32 of the rotation wheel 3 extends out from the hollow seal 21 and passes through the center hole of the externally covered ring mechanism 1. The supporting rod 22 is mounted each at the lateral side of the power rotation wheel 3 and are of similar structure.

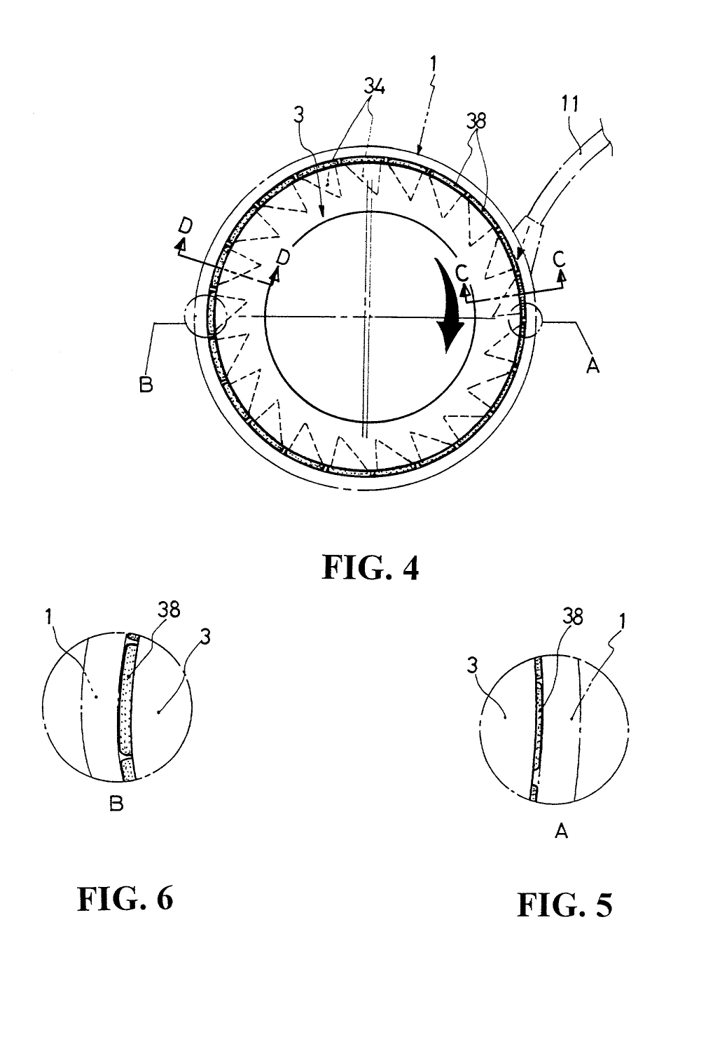

The supporting rod 22 has two rod bodies which are respectively supported and engaged at the hollow seal 21, wherein the front section of the rod body 220 has an arch-shaped locking head 222, and has an extension spring 223 urging the external section of the externally covered ring mechanism 1 to provide slight eccentricity. The rod body 220 is directly passed through the protruded seat 12 from the covered ring 1 and is connected with the screw hole 212 at the end head of the hollow seal 21. The end head of the supporting rod 22 is positioned and engaged by means of a locking head 224; and the front end of the rear section of the rod body 220 is similarly connected to the screw hole of the hollow seal 21. The end head has a locking head 224-1 to engage at the external side of the hollow seal 21, and the rear end of the rod body 22 passes through from the protruded seat 12 and is locked thereto. In accordance with the present invention, the power rotation wheel mechanism 3 can rotate within the externally covered ring mechanism 1 and is eccentrically mounted with respect to inner edge surface of the externally covered ring 3 (as shown in FIGS. 4, 5 and 6).

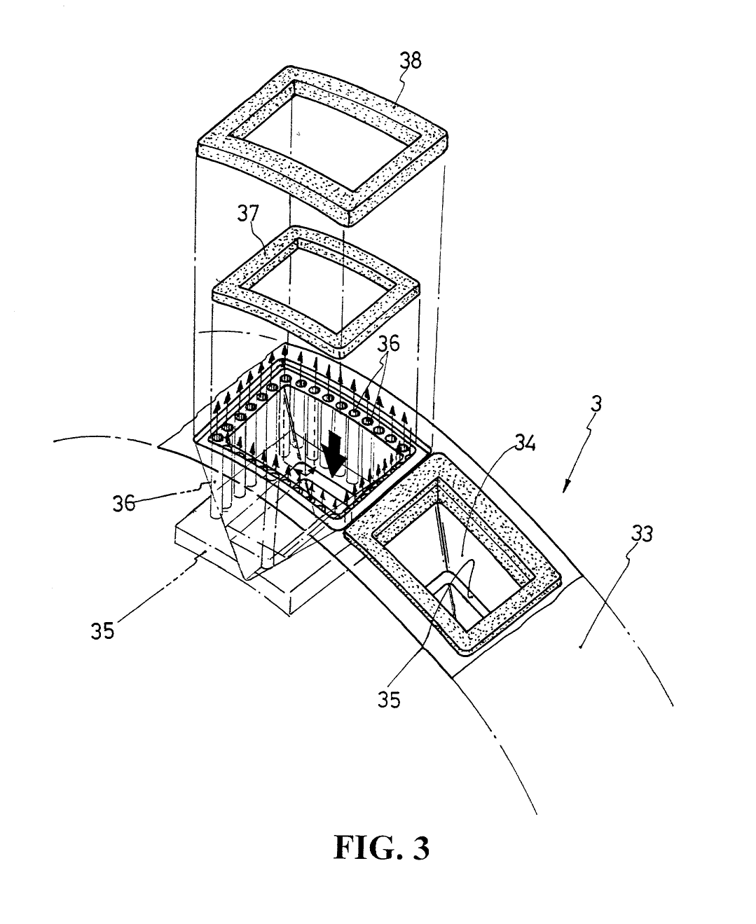

As shown in FIG. 3, the power rotation wheel mechanism 3 has an external edge surface 33 with periodic ejection slot 34 and each ejection slot 34 is an independent structure. The inner bottom section of the slot 34 is provided with a passage 35 which is in communication with the pressure hole 36 at the circumferential side of the ejection slot 34. The surface of the slot 34 is mounted with a high elasticity rubber pad 37 and a secondary pad ring 38 of the wear-resistant is mounted onto the pressure hole 36 of the circumferential edge, the ejection hole 34 as shown at the right side of FIG. 3.

In accordance with the preferred embodiment of the present invention, when the ejection conduit 11 ejects power (for instance hydraulic pressure ejection, water stream ejection, (etc) to the ejection slot 34, the ejection pressure passes through the passage 35 at the bottom section into the individual pressure hole 36 to form external impact force. At this instance, the high elasticity rubber pad 37 and the wear-resistant secondary pad ring 38 will protruded upward (due to surrounding uniform impact force) and attain at the inner edge face of the externally covered ring 1 such that the entire ejection slot 34 automatic closes the operation mechanism In other words, the mechanism of the operation of automatic closing structure due to impact pressure can completely be absorbed and is subjected to liquid state ejection power, forming a reaction force from the actin of the ejection. Thus, the power rotation wheel mechanism 3 is urged, forming into continuous close-type ejection rotation mechanism as shown in FIG. 4.

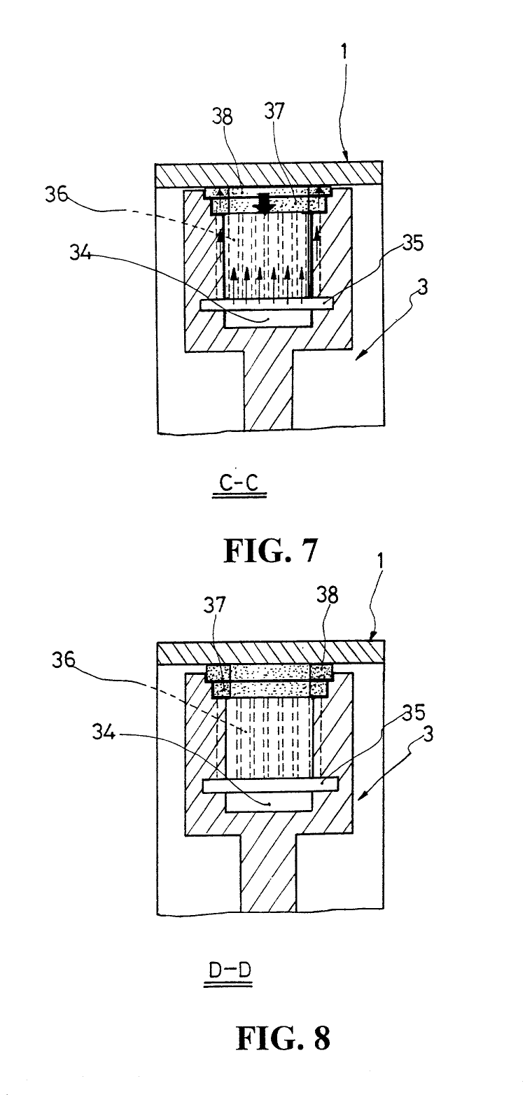

Referring to FIG. 4, the power rotation wheel mechanism 3 is at an eccentric position such that the inner edge surface forms into an outer edge having one side being near to the rotation wheel 3, and the other side has an appropriate distance with the outer edge of the rotation wheel 3. As shown in FIGS. 5 and 6, the secondary pad ring 38 positioned at the ejection slot 34 of the rotation wheel 3 is closely pressed against the inner edge face of the externally covered ring 1. The secondary pad ring 38 at the other side of the ejection slot 34 does not closely contact with the inner edge face of the externally covered ring 1. As shown in FIGS. 7 and 8, when the power rotation wheel mechanism 3 rotates, the reaction of the secondary pad ring 38 rotates in accordance with the rotation wheel mechanism 3 and in turn, it forms an eccentric rotation with respect to the externally covered ring mechanism 1. The operation of each ejection slot 34 has two types, i.e., a slightly press against or not pressing status. When the ejection slot 34 passes through the ejection fixed point and subject to ejection power, automatic closing is in operation.

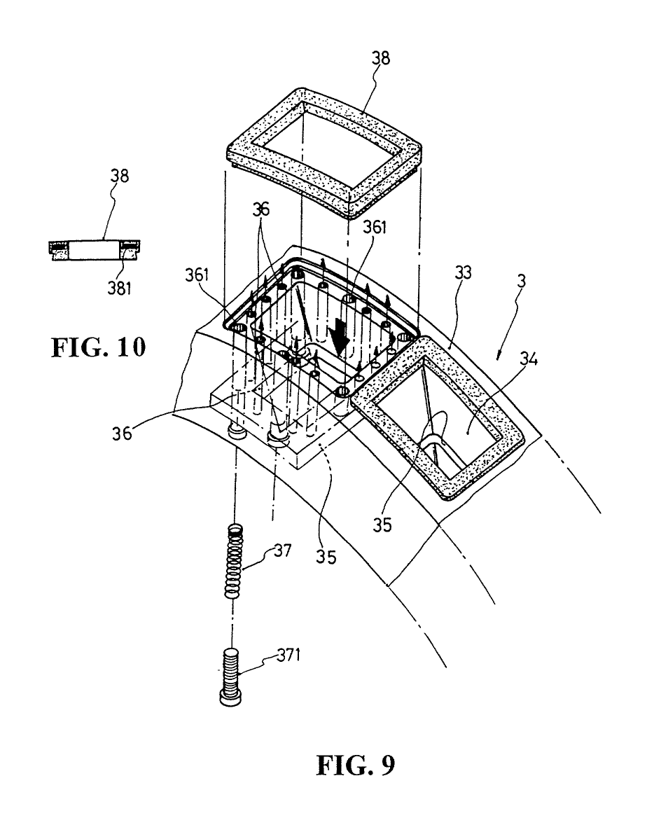

FIG. 9 is a second preferred embodiment in accordance with the present invention. The high elasticity rubber pad 38 can be removed and substituted with a plurality of holes 361, and the inner bottom section of the hole 361 is provided with an extension spring 372 and is locked by a locking nut 371. Due to the action of the extension spring 372, the secondary pad ring 38 at the ejection slot 34 is formed into an equivalent spring force. The secondary pad ring 38 has a hard board plate 381 so as to reinforce the stress of the secondary pad ring 38, as shown in FIG. 10.

While the invention has been described with respect to preferred embodiments, it will be clear to those skilled in the art that modifications and improvements may be made to the invention without departing from the spirit and scope of the invention. Therefore, the invention is not to be limited by the specific illustrative embodiment, but only by the scope of the appended claims.

I claim:

1. An ejection rotation power mechanism comprising (a) an externally covered ring mechanism, (b) an eccentric supporting rod mechanism, and (c) a power rotation wheel mechanism, wherein:
(a) the externally covered ring is associated with the power rotation wheel mechanism connected tangentially with an injection conduit and an oil-dripping tube; and the eccentric supporting rod mechanism is provided to the two lateral sides of the interior of the externally covered ring, the eccentric supporting rod mechanism is positioned eccentrically within the interior of the power rotation mechanism, the front and rear of the horizontal interior of the externally covered ring are provided with a through protruded seat, when the inner power rotation wheel is in operation, the externally covered ring mechanism is stationery;
(b) the eccentric supporting rod mechanism comprises a hollow seal module and a supporting rod, wherein the hollow seal has a bearing for the insertion of the shaft of the power rotation wheel and the shaft center of the rotation wheel extends out from the hollow seal and passes through the center hole of the externally covered ring mechanism;
(c) the supporting rod has two rod bodies which are respectively supported and engaged at the hollow seal, wherein the front section of the rod body has an arch-shaped locking head, and has an extension spring urging the external section of the externally covered ring mechanism to provide slight eccentricity; the rod body is directly through the protruded seat from the covered ring and is screwed connected with the screw hole at the hollow seal, the end head of the supporting rod is positioned and engaged by means of a locking head; the front end of the rear section of the rod body is similarly connected to the screw hole of the hollow seal, the end head has a locking head to engage at the external side of the hollow seal, the rear end of the rod body passes through from the protruded seat and is locked thereto;
(d) the power rotation wheel mechanism has an external edge surface with periodic ejection slot and each ejection slot is an independent structure, the inner bottom section of the slot is provided with a passage which is in communication with the pressure hole at the circumferential side of the ejection slot; the surface of the slot is mounted with a high elasticity rubber pad and a secondary pad ring mounted onto the pressure hole of the circumferential edge.

2. An ejection rotation power mechanism as set forth in claim 1, wherein the externally covered ring mechanism and the power rotation wheel mechanism are slightly eccentrically mounted, and one lateral side of the inner edge surface of the externally covered ring is closely positioned at the external edge of the rotation wheel, and the other lateral side has an appropriate distance from the external edge of the rotation wheel.

3. An ejection rotation power mechanism as set forth in claim 1, wherein the inner bottom section of the hole at the circumferential edge of the ejection slot is provided with an extension spring and is locked by a nut.
